(19) United States
(12) Patent Application Publication
(10) Pub. No.: US 2008/0243503 A1
(43) Pub. Date: Oct. 2, 2008

(54) MINIMUM DIVERGENCE BASED DISCRIMINATIVE TRAINING FOR PATTERN RECOGNITION

(75) Inventors: Frank Kao-Ping Soong, Beijing (CN); Peng Liu, Beijing (CN); Jian-Iai Zhou, Beijing (CN); Dongmei Zhang, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/694,375

(22) Filed: Mar. 30, 2007

(51) Int. Cl. G10L 15/06

(52) U.S. Cl. 704/244

(57) ABSTRACT

A method of providing discriminative training of a speech recognition unit is discussed. The method includes receiving an acoustic indication of an utterance having a hypothesis space and comparing the hypothesis space against a reference. The method measures the Kullback-Leibler Divergence (KLD) between the reference and the hypothesis space to adjust the reference and stores the adjusted reference on a tangible storage medium.

### BACKGROUND

Discriminative training has been shown to be an effective way to reduce word error rates in Hidden Markov Model (HMM) based automatic speech recognition systems. Known discriminative criteria, including Maximum Mutual Information (MMI) and Minimum Classification Error (MCE) have been shown to be effective on small-vocabulary tasks. However, such discriminative criteria are not particularly effective when used in Large Vocabulary Continuous Speech Recognition databases and significant improvements to these criteria have been difficult to accomplish. Other criteria such as Minimum Word Error (MWE) and Minimum Phone Error (MPE), which are based on error measured at a word or phone level, have been proposed to improve recognition performance.

From a unified viewpoint of error minimization, MCE, MWE and MPE differ only in error definition. String-based MCE is based upon minimizing sentence error rate and MWE is based upon minimizing on word error rate, which is more consistent with the popular metric used in evaluating automatic speech recognition systems. Hence, the latter tends to yield better word error rate. However, MPE performs slightly but universally better than MWE. The success of MPE might be explained as follows. When refining acoustic models in discriminative training, it makes more sense to define errors in a more granular form of acoustic similarity. However, binary decision at phone label level is only a rough approximation of acoustic similarity. The error measure can be easily influenced by the choice of language model and phone set definition. For example, in a recognition system where whole word models are used, phone errors cannot be computed.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

In one embodiment, a method of providing discriminative training of a speech recognition unit is discussed. The method includes receiving an acoustic indication of an utterance having a hypothesis space. The hypothesis space is compared against a reference. The Kullback-Leibler Divergence between the reference and the hypothesis space to adjust the reference, and the adjusted reference is stored on a tangible storage medium

In another embodiment, a method of automatically recognizing a pattern is discussed. The method includes receiving pattern training data configured to train a pattern recognition model and aligning the pattern training data with a portion of the pattern recognition model. The method further includes measuring a pattern similarity by calculating a gain between the pattern training data and the pattern recognition model and adjusting the pattern recognition model to account for the pattern training data. The adjusted speech recognition model is then provided to a pattern recognition application stored on a tangible computer medium.

In still another embodiment, a pattern recognition system configured to train a model having a plurality of parameters is discussed. The pattern recognition system includes a data store located on a tangible computer medium and configured to accept pattern training data and a discriminative training engine configured to receive an observation and compare the observation with a portion of the pattern training data. The discriminative training engine is configured to employ a minimum divergence based discriminative training algorithm to modify the pattern training data.

### BRIEF DESCRIPTION OF THE DRAWINGS

FIG. 1 is a block diagram of a training system employing discriminative training for a speech recognition system according to one illustrative embodiment.

FIG. 2 is a table illustrating criterion for a plurality of discriminative training approaches for the system of FIG. 1.

FIG. 3 is flow diagram illustrating a method of training of a speech recognition system by using minimum divergence to measure errors according to one illustrative embodiment.

FIG. 4 is a diagram of a word graph aligned with a reference for the purpose of comparing an observation hypothesis with the reference according illustrative embodiment.

FIG. 5 is a chart comparing the results of a minimum divergence based determinative training method compared against a minimum phone error based determinative training method.

FIG. 6 is a chart illustrating the results of a minimum divergence based determinative training method compared against a minimum phone error based determinative training method employing a smoothing constant.

FIG. 7 is a chart illustrating the results of serveral iterations of a minimum divergence based determinative training method compared against a minimum phone error based determinative training method.

FIG. 8 is a block diagram of one computing environment in which some embodiments may be practiced.

### DETAILED DESCRIPTION

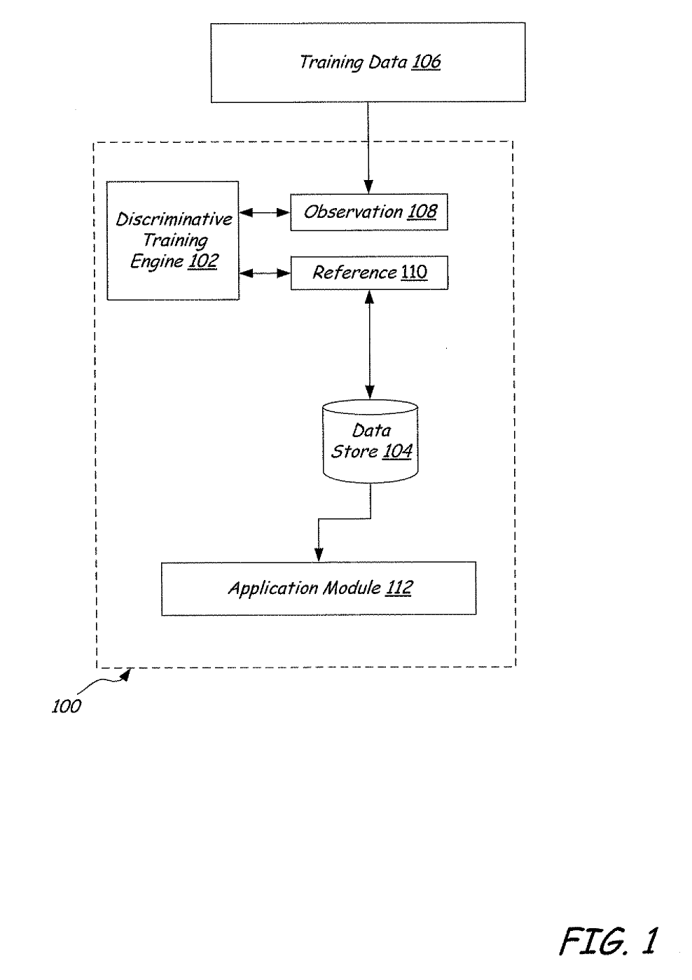

FIG. 1 illustrates a speech recognition system 100 including a training engine 102 for training a minimum divergence based discriminative model according to one illustrative embodiment. The speech recognition system 100 includes a data store 104, which provides storage for the discriminative model. The details of the discriminative model will be discussed in more detail below. Training data 106 provides an observation 108, which is compared against a reference 110 by the training engine 102. The training engine 102 will, in one illustrative embodiment, modify the reference 110 based upon errors that are uncovered through the comparison of the reference 110 with the observation 108. The reference 110 is then provided again to the data store 104. It should be appreciated that each reference provided by the data store 104 to the training engine 102 is a part of the discriminative model. The discriminative model is then provided to an application module 112, which is used to perform automated speech recognition.

The discriminative model illustratively includes a training criteria, described by an objective function, which it uses to evaluate the reference 110 against the observation 108 to measure an error Various discriminative training criteria are investigated in terms of corresponding error measures, where the objective function is illustratively an average of the transcription accuracies of all hypotheses weighted by the posterior probabilities. The objective function [symbol] (θ) in a single utterance case can be expressed as:

$$ℱ ( θ ) = {\sum }_{𝒲 ∈ ℳ}^{ } {𝒫}_{θ} ( W \vert O ) 𝒜 ( W , {W}_{r} )$$

where θ represents the set of model parameters, O is a sequence of acoustic observation vectors, Wᵣ is the reference word sequence; [symbol] (W|O) is a generalized posterior probability of an observation, W, given feature O, and [symbol] is the hypotheses space. The term Wᵣ represents an acoustic reference word sequence against which the acoustic observation W is compared P_{θ}(W|O) is illustratively be characterized as follows.

$${P}_{θ} ( W \vert O ) = \frac{{P}_{θ}^{κ} ( O \vert W ) P ( W )}{{\sum }_{{W}^{′} ∈ ℳ} {P}_{θ}^{κ} ( O \vert {W}^{′} ) P ( {W}^{′} )}$$

where k is the acoustic scaling factor.

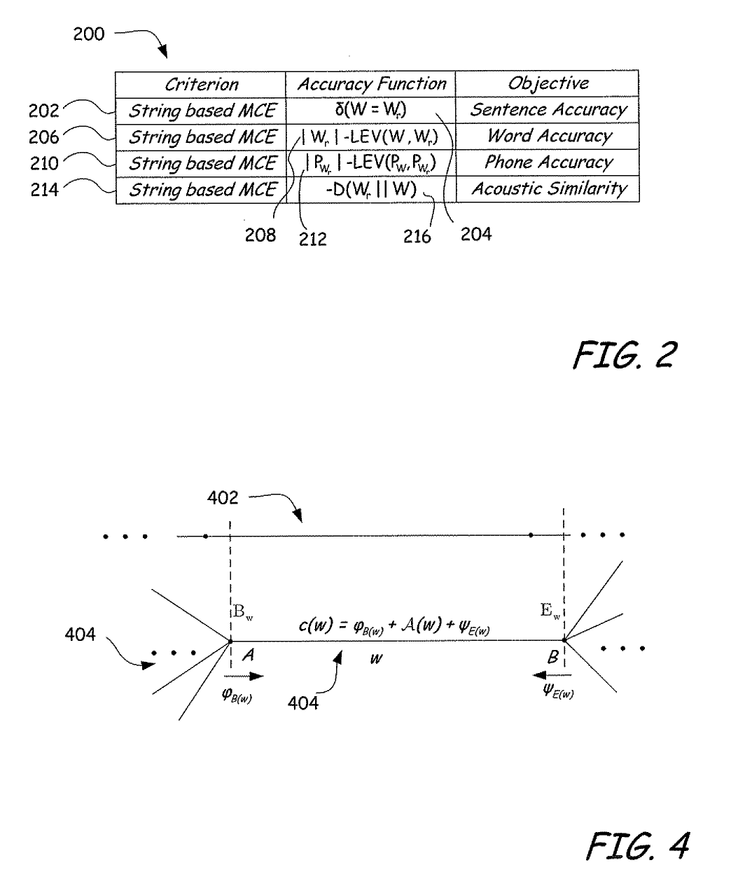

The [symbol] (W,Wᵣ) term is an accuracy term. FIG. 2 illustrates a table 200 that describes an accuracy term A(W,Wᵣ) for the objective function F(θ) given different types of discriminative criteria. Row 202 represents a string based Minimum Classification Error (MCE), which has, as its objective, sentence accuracy. The accuracy term 204 is illustratively an impulse function δ(W=Wᵣ). The accuracy term 204 thus has a value of 1 if the observation matches the reference and a value of 0 otherwise.

In row 206, an accuracy term 208 for a Minimum Word Error (MWE) criterion is described. The MWE criterion has, as its objective, word accuracy. The accuracy term 108 is described as |Wᵣ|−LEV(W,Wᵣ), where LEV(W,Wᵣ) is the Levenshtein Distance between the observation W and the reference Wᵣ. In row 210, an accuracy term 212 for a Minimum Phone Error (MPE) criterion is described. The MPE criterion has, as its objective, phone accuracy. The accuracy term 212 is described as |P_{W}_{ᵣ}|−LEV(P_{W},P_{W}_{ᵣ}), where P_{W} is an observed phone and P_{W}_{ᵣ} is a reference phone.

Row 214 illustrates an accuracy term 216 for a Minimum Divergence (MD) criterion. The Minimum Divergence criterion can be described as −D(Wᵣ∥W), which is represents an adoption of Kullback-Leibler Divergence (KLD) to measure the acoustic similarity between the observation and the reference.

In one illustrative embodiment, a word sequence is characterized by a sequence of Hidden Markov Models (HMMs). For automatically measuring acoustic similarity between the observation and the reference, a KLD is adopted between the corresponding HMMs. Thus, the accuracy term of the objective function F(θ) can be written as:

A(W,Wᵣ)=−D(Wᵣ∥W).

HMMs are, in one illustrative embodiment, reasonably well trained in the maximum likelihood (ML) sense. As such, the HMMs serve as succinct descriptions of data. By adopting the MD criterion, acoustic models are illustratively refined more directly by measuring discriminative information between a reference and other hypotheses.

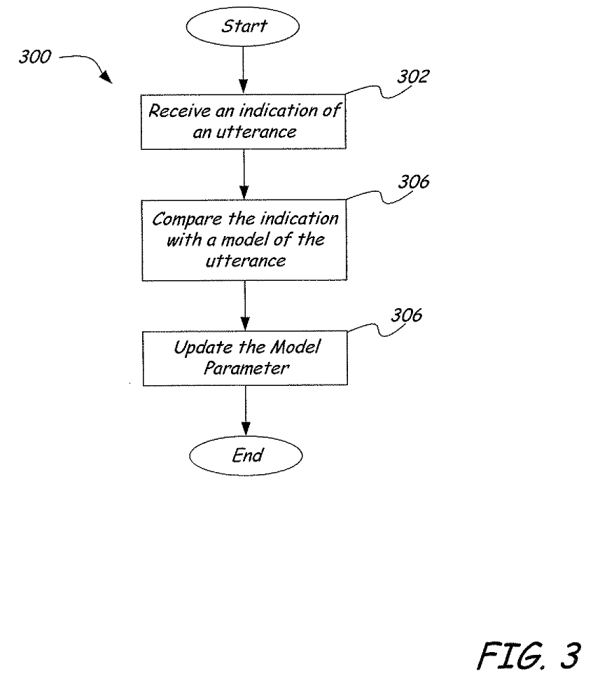

FIG. 3 illustrates a method 300 for using minimum divergence to measure errors in discriminative training according to one illustrative embodiment. In the method 300, an indication of utterance in the form of training data 106 is received as an observation by the system 100 (shown in FIG. 1), which is illustrated in block 302. In one illustrative embodiment, the indication received includes a sequence of HMMs that describe the utterance. The utterance is illustratively a known utterance, that is, the utterance is a pronunciation of a particular phone, word, phrase, etc.

The indication of the utterance is then compared against a reference of the utterance, as is indicated by block 304. In one illustrative embodiment, the step of comparing the indication of the utterance against the known model of the utterance includes measuring the Kullback-Leibler Divergence (KLD) between the indication of the utterance and the reference. Given the indication of the utterance, W, and the reference, \tilde{W}, comparing W and \tilde{W} is achieved by measuring the KLD between corresponding HMMs. The indication W and the reference \tilde{W} are matched using a state matching algorithm. State output distributions are illustratively characterized by Gaussian mixture models (GMMs), which provide no closed form solutions for KLDs. However, unscented transforms have proven to be effective for approximating KLD between GMMs. Thus,

$$D ( s \vert \vert \tilde{s} ) \approx \frac{1}{2 N} {\sum }_{m = 1}^{M} {ω}_{m} {\sum }_{k = 1}^{2 N} log \frac{p ( {o}_{m , k} \vert s )}{p ( {o}_{m , k} \vert \tilde{s} )}$$

where s and \tilde{s} are GMMs of W and \tilde{W}, respectively. N is the number of Gaussian kernels, and M is the number of mixture components in each GMM. ωₘ is the weight of the mth kernel and o_{m,k} is the kth sigma point in the mth Gaussian kernel of p(o_{m,k}|s).

FIG. 4 illustrates a word graph 400 compared to a reference 402 aligned with the word graph 400. The word graph 400 is illustratively a compact representation from A to B of large hypotheses space 404 of an observation W in speech recognition. The hypotheses space 204 includes a beginning point indentified as B_{w} and an ending point indentified as E_{w}. The calculation of of statistics for minimum divergence training is illustratively accomplish by employing a forward-backward algorithm. For each hypothesis space, w, the following calculation is made:

c(w)=φ_{B(w)}+A(w)+ψ_{E(w)}

where A(w) is the accuracy term, φ_{B(w)} represents a forward probability calculation from the beginning point B_{w} of the hypothesis space w and ψ_{E(w)} represents a backward probabily calculation from the ending point E_{w} of the hypothesis space w. The forward-backward algorithm is calculated by first calculating A(w). As discussed above, A(w) is illustratively calculated by finding the minimum divergence, which is approximated by calculating GMMs. The N nodes are sorted so that nₒ [symbol] nₗ . . . [symbol] n_{N}.

The forward probability calculation is illustratively calculated as follows. For the purposes of initialization, σₙ_{ₒ}=1,φₙ_{ₒ}=0. Then, for each Gaussian kernel nᵢ from 1 to N, the following calculations are made:

$${σ}_{{n}_{i}} = {\sum }_{m ∈ P ( {n}_{i} )} {σ}_{m} \cdot P ( {w}_{m , {n}_{i}} )$$

$${φ}_{{n}_{i}} = \frac{1}{{σ}_{{n}_{i}}} {\sum }_{m ∈ P ( {n}_{i} )} [ {φ}_{m} + 𝒜 ( {w}_{m , {n}_{i}} ) ] \cdot {σ}_{m} \cdot P ( {w}_{m , {n}_{i}} )$$

The backward probability is calculated as follows. For the purposes of initialization, βₙ_{_{N}}=1, ψₙ_{_{N}}=0. Then, for each Gaussian kernel n, from N down to 1, the following calculations are made:

$${σ}_{{n}_{i}} = {\sum }_{m ∈ P ( {n}_{i} )} {σ}_{m} \cdot P ( {w}_{m , {n}_{i}} )$$

$${φ}_{{n}_{i}} = \frac{1}{{σ}_{{n}_{i}}} {\sum }_{m ∈ P ( {n}_{i} )} [ {φ}_{m} + 𝒜 ( {w}_{m , {n}_{i}} ) ] \cdot {σ}_{m} \cdot P ( {w}_{m , {n}_{i}} )$$

Returning again to FIG. 3, once the statistics have been calculated, the model parameters (associated with the reference 110) of the training data are updated and sent to data store 104, as is illustrated in block 306. In one illustrative embodiment, the model parameters are updated using the Extended Baum-Welch algorithms, although any other suitable method may be used.

Alternatively, the step 306 of updating the model parameters can include an I-smoothing step for discriminitive training. The I-smoothing is illustratively performed by interpolating between statistics of ML training and discriminative training. The I-smoothing includes adding τ points of ML statistics to numerator statistics of discriminative training. The τ points illustratively provide the smoothing constant to control the interpolation.

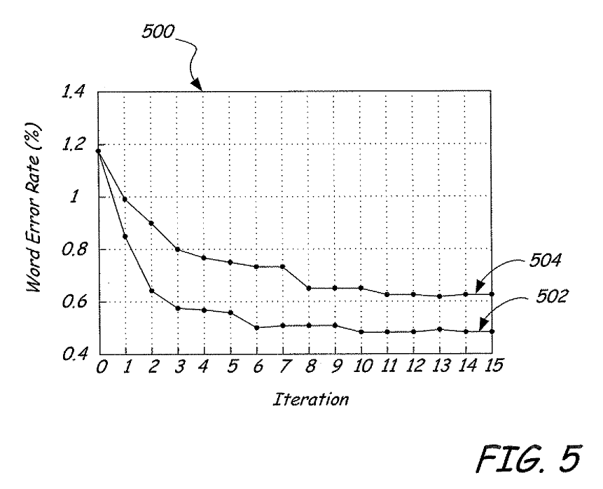

Experiments were conducted utilizing embodiments of the system and method described above on a database having a corpus vocabulary of the digits “one” to “nine”, as well as “oh” and “zero”. All four categories of speakers, i.e. men, women, boys, and girls, were used for both training and testing. The models for the digits used 39-dimensional Mel-frequency cepstral coefficient (MFCC) features. All digits were modeled using 10-state, left-to-right whole word HMMs with Gaussians per state. Because the HMMs were whole word models, the minimum phone error (MPE) was equivalent to the minimum word error (MWE). The acoustic scaling factor κ was set to 1/33 and I-smoothing was not employed. FIG. 5 includes a chart 500, which illustrates the performance of the MD model 502 and an MPE model 504 when tested on the digits vocabulary described above. The resulting word error rate is plotted against iterations. The performance of the MD model 502 is shown to be superior the MPE model 504, in that it has a reduced word error rate for each of the iterations.

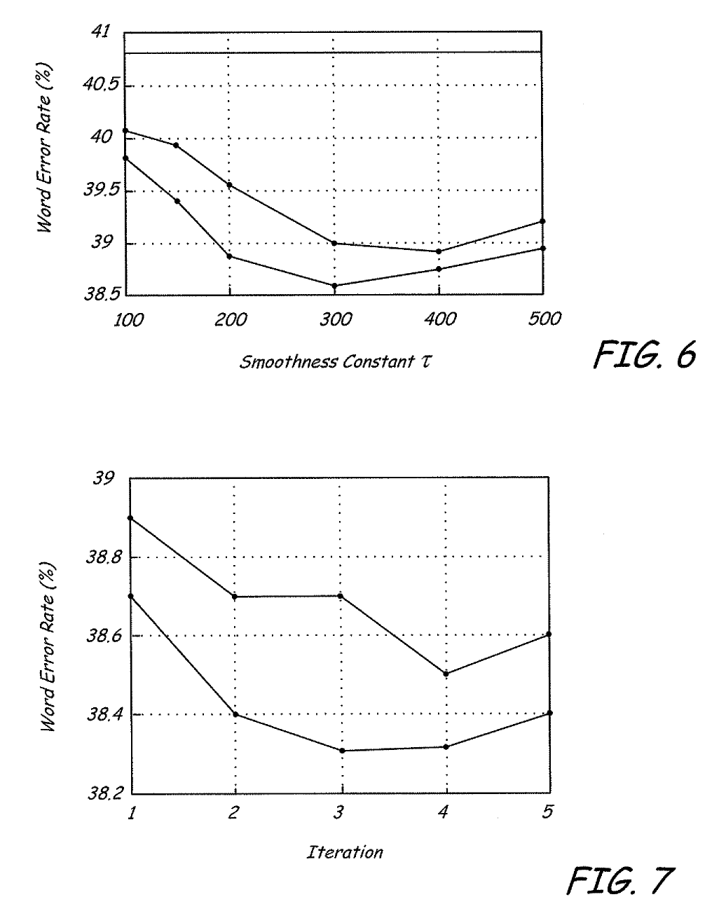

In another experiment, the MD and MPE models are compared in performance against the Switchboard corpora. The models were trained using a 39-dimensional Perceptual Lnear Prediction feature. Each tri-phone is modeled by a 3-state HMM. In total, there are 1500 states with 12 GMMs per state. The acoustic scaling factor κ was set to 1/15 and I-smoothing was employed. A baseline of an ML training model provided a word error rate of 40.8%. The smoothing constant τ is used to interpolate the contributions between ML and the discriminative training. FIG. 6 has a chart 510 that illustrates the results of a first iteration using various values for the smoothing constant τ. It was seen that varying the smoothing constant resulted in varying word error rates. In each case, the MD model 512 has lower word error rate than either of the baseline ML model 514 and the MPE model 516. In one embodiment, a smoothing constant τ of about 300 to 400. Subsequent iterations were run at τ=400, the results of which are shown in FIG. 7 After four iterations, the MD model 520 achieved about 6% relative error reduction compared to the MPE model 522. The results show consistent improvement for the minimum divergence based discriminative training.

The embodiments discussed above provide important advantages. Measuring the KLD between two given HMMs provide a physically more meaningful assessment of the acoustic similarity between an utterance and a given reference. Given sufficient training data, HMMs can be adequately trained to represent the underlying distributions and then can be used for calculating KLDs. The minimum divergence criterion advantageously employs acoustic similarity for high-resolution error definition, which is directly related with providing improved acoustic model refinement, In addition, label comparison is no longer used, which alleviates the influence of chosen language models and phone sets. Therefore, the hard binary decisions caused by label matching are avoided.

Furthermore, the embodiments discussed above can be applied to applications other than speech recognition. MD models can be adapted other types of recognition such as handwriting recognition. Such recognition is not meaningful using criteria such as MPE, which focus on localizing errors.

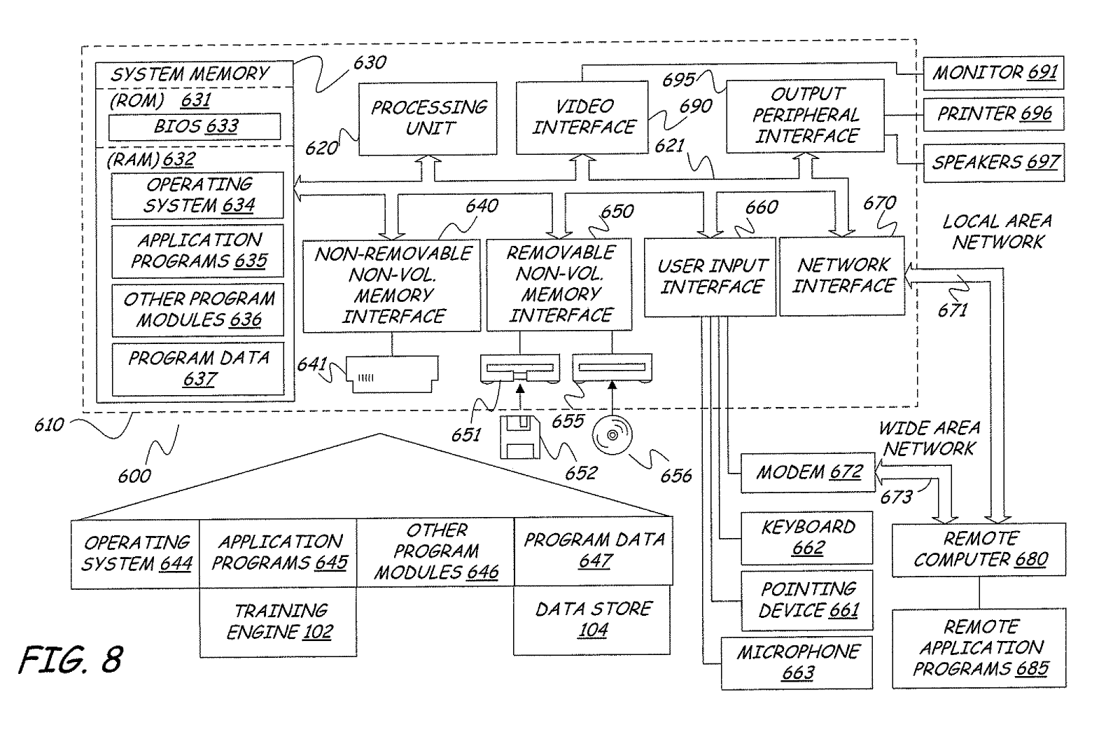

FIG. 8 illustrates an example of a suitable computing system environment 600 on which embodiments may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 8, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 8 illustrates operating system 634, application programs 635, other program modules 636, and program data 637.

The computer 610 may also include other removable/non-removable volatile/nonvolatile computer storage media. By way of example only, FIG. 8 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 8, provide storage of computer readable instructions, data structures, program modules and other data for the computer 610. In FIG. 8, for example, hard disk drive 641 is illustrated as storing operating system 644, application programs 645, which includes the training engine 102, other program modules 646, and program data 647, including data store 104. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 8 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 8 illustrates remote application programs 685 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of providing discriminative training of a speech recognition unit, comprising:
receiving an acoustic indication of an utterance having a hypothesis space;
comparing the hypothesis space against a reference;
measuring the Kullback-Leibler Divergence (KLD) between the reference and the hypothesis space to adjust the reference; and
storing the adjusted reference on a tangible storage medium.

2. The method of claim 1, and further comprising:
smoothing the minimum divergence based discriminative training by interpolating between the minimum divergence and a maximum likelihood calculation.

3. The method of claim 2, wherein interpolating between the divergence and a maximum likelihood includes applying a smoothing constant.

4. The method of claim 1, wherein measuring the KLD includes employing a forward-backward algorithm.

5. The method of claim 1, wherein comparing the hypothesis space against a reference comprises:
calculating a posterior probability.

6. The method of claim 1, wherein comparing the hypothesis space against a reference comprises:
calculating a gain function indicative of an accuracy measure of the hypothesis space given the reference.

7. The method of claim 6 wherein calculating the gain function includes calculating an indication of the acoustic similarity of the hypothesis space given the reference.

8. The method of claim it wherein adjusting the reference includes adopting an Extended Baum-Welch algorithm to update a parameter.

9. The method of claim 1, wherein receiving the acoustic indication includes receiving a plurality of Hidden Markov Models.

10. A method of automatically recognizing a pattern, comprising:
receiving pattern training data configured to train a pattern recognition model;
aligning the acoustic training data with a portion of the pattern recognition model;
calculating a gain indicative of a similarity between the pattern training data and the pattern recognition model;
adjusting the pattern recognition model to account for the pattern training data; and
providing the adjusted pattern recognition model to a pattern recognition application stored on a tangible computer medium

11. The method of claim 10, wherein receiving pattern data includes receiving speech pattern data configured to train an acoustic speech recognition model.

12. The method of claim 10, wherein calculating a gain includes calculating a Kullback-Leibler Divergence (KLD) between a portion of pattern training data and the recognition model.

13. The method of claim 10, wherein calculating a gain includes employing a forward-backward algorithm over a portion of the pattern training data.

14. The method of claim 10 and further comprising:
employing a smoothing algorithm by applying a constant indicative of a maximum likelihood statistic to adjust the calculated gain.

15. The method of claim 14, wherein employing the smoothing algorithm includes interpolating between the maximum likelihood statistic and the gain.

16. A pattern recognition system configured to train a model having a plurality of parameters, comprising:
a data store located on a tangible computer medium and configured to accept pattern training data;
a discriminative training engine configured to receive an observation and compare the observation with a portion of the pattern training data; and
wherein the discriminative training engine is configured to employ a minimum divergence based discriminative training algorithm to modify the pattern training data.

17. The system of claim 16, wherein the discriminative training engine is configured to calculated a KLD between a portion of the pattern training data and the observation.

18. The system of claim 16 and further comprising:
an application module configured to access the pattern training data.

19. The system of claim 16, wherein the pattern training data includes a plurality of Hidden Markov Models.

20. The system of claim 16, wherein the discriminative training engine is configured to apply a smoothing algorithm to the pattern training data.
